(19) United States
(12) Patent Application Publication
(10) Pub. No.: US 2004/0059704 A1
(43) Pub. Date: Mar. 25, 2004

(54) Self-managing computing system

(75) Inventors: Joseph L. Hellerstein, Ossining, NY (US); Jeffrey Owen Kephart, Cortlandt Manor, NY (US); Edwin Richie Lassettre, Los Gatos, CA (US); Norman J. Pass, Sunnyvale, CA (US); David Robert Safford, Brewster, NY (US); William Harold Tetzlaff, Mount Kisco, NY (US); Steve Richard White, New York, NY (US)

Correspondence Address: Carstens, Yee and Cahoon, L.L.P., P.O. Box 802334, Dallas, TX, 75380, US

(73) Assignee: International Business Machines Corporation, Armonk, NY

(21) Appl. No.: 10/252,247

(22) Filed: Sep. 20, 2002

(51) Int. Cl. G06F 7/00

(52) U.S. Cl. 707/1

(57) ABSTRACT

A method, computer program product, and data processing system for constructing a self-managing distributed computing system comprised of “autonomic elements” is disclosed. An autonomic element provides a set of services, and may provide them to other autonomic elements. Relationships between autonomic elements include the providing and consuming of such services. These relationships are “late bound,” in the sense that they can be made during the operation of the system rather than when parts of the system are implemented or deployed. They are dynamic, in the sense that relationships can begin, end, and change over time. They are negotiated, in the sense that they are arrived at by a process of mutual communication between the elements that establish the relationship.

### CROSS REFERENCE TO RELATED APPLICATIONS

The present invention is related to the following applications entitled: “Method and Apparatus for Publishing and Monitoring Entities Providing Services in a Distributed Data Processing System”, Ser. No. ______, attorney docket no. YOR920020173US1; “Method and Apparatus for Automatic Updating and Testing of Software”, Ser. No. ______, attorney docket no. YOR920020174US1; “Composition Service for Autonomic Computing”, Ser. No. ______, attorney docket no. YOR920020176US1; and “Adaptive Problem Determination and Recovery in a Computer System”, Ser. No. ______, attorney docket no. YOR920020194US1; all filed even date hereof, assigned to the same assignee, and incorporated herein by reference.

### BACKGROUND OF THE INVENTION

1. Technical Field

The present invention relates generally to an improved data processing system, and in particular, to a method and apparatus for managing hardware and software components. Still more particularly, the present invention provides a method and apparatus for automatically identifying and self-managing hardware and software components to achieve functionality requirements.

2. Description of Related Art

Modern computing technology has resulted in immensely complicated and ever-changing environments. One such environment is the Internet, which is also referred to as an “internetwork.” The Internet is a set of computer networks, possibly dissimilar, joined together by means of gateways that handle data transfer and the conversion of messages from a protocol of the sending network to a protocol used by the receiving network. When capitalized, the term “Internet” refers to the collection of networks and gateways that use the TCP/IP suite of protocols. Currently, the most commonly employed method of transferring data over the Internet is to employ the World Wide Web environment, also called simply “the Web”. Other Internet resources exist for transferring information, such as File Transfer Protocol (FTP) and Gopher, but have not achieved the popularity of the Web. In the Web environment, servers and clients effect data transaction using the Hypertext Transfer Protocol (HTTP), a known protocol for handling the transfer of various data files (e.g., text, still graphic images, audio, motion video, etc.). The information in various data files is formatted for presentation to a user by a standard page description language, the Hypertext Markup Language (HTML). The Internet also is widely used to transfer applications to users using browsers. Often times, users of may search for and obtain software packages through the Internet.

Other types of complex network data processing systems include those created for facilitating work in large corporations. In many cases, these networks may span across regions in various worldwide locations. These complex networks also may use the Internet as part of a virtual product network for conducting business. These networks are further complicated by the need to manage and update software used within the network.

As software evolves to become increasingly ‘autonomic’, the task of managing hardware and software will, more and more, be performed by the computers themselves, as opposed to being performed by administrators. The current mechanisms for managing computer systems are moving towards an “autonomic” process, wherein computer systems are self-configuring, self-optimizing, self-protecting, and self-healing. For example, many operating systems and software packages will automatically look for particular software components based on user-specified requirements. These installation and update mechanisms often connect to the Internet at a preselected location to see whether an update or a needed component is present. If the update or other component is present, the message is presented to the user in which the message asks the user whether to download and install the component. An example of such a system is the package management program “dselect” that is part of the open-source Debian GNU/Linux operating system. Some virus checking programs run in the background (as a “daemon” process, to use Unix parlance) and can automatically detect viruses, remove them, and repair damage.

A next step towards “autonomic” computing involves identifying, installing, and managing necessary hardware and software components without requiring user intervention. Thus, a need exists in the art for more automated processes for identifying, installing, configuring and managing hardware and software components.

### SUMMARY OF THE INVENTION

The present invention is directed toward a method, computer program product, and data processing system for constructing a self-managing distributed computing system comprised of “autonomic elements.” An autonomic element provides a set of services, and may provide them to other autonomic elements. Relationships between autonomic elements include the providing and consuming of such services. These relationships are “late bound,” in the sense that they can be made during the operation of the system rather than when parts of the system are implemented or deployed. They are dynamic, in the sense that relationships can begin, end, and change over time. They are negotiated, in the sense that they are arrived at by a process of mutual communication between the elements that establish the relationship. Policies, including constraints and preferences, may be specified to an autonomic element. Any relationship established by an autonomic element must be consistent with the policy of that autonomic element. During the course of a relationship, an autonomic element must attempt to adjust its behavior to be consistent with the policy.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a diagram of a networked data processing system in which the present invention may be implemented;

FIG. 2 is a block diagram of a server system within the networked data processing system of FIG. 1;

FIG. 3 is a block diagram of a client system within the networked data processing system of FIG. 1;

FIG. 4 is a diagram of an autonomic element in accordance with a preferred embodiment of the present invention;

FIG. 5 is a diagram a mechanism for establishing service-providing relationships between autonomic elements in accordance with a preferred embodiment of the present invention;

FIG. 6 is a diagram providing a legend for symbols in E-R (entity-relationship diagrams) as used in this document;

FIG. 7 is a diagram of an example database schema for a directory service in accordance with a preferred embodiment of the present invention;

FIGS. 8-9 diagrams depicting an example of an autonomic element utilizing the services of another autonomic element in accordance with a preferred embodiment of the present invention;

FIG. 10 is an E-R diagram depicting how the terms of a relationship between two autonomic elements may be governed by a policy in accordance with a preferred embodiment of the present invention;

FIG. 11 is a flowchart representation of a process of negotiating terms of a relationship between two autonomic elements as seen from the perspective of one of the elements in accordance with a preferred embodiment of the present invention;

FIGS. 12-15 are diagrams depicting an example of fault detection and handling in an autonomic computing system in accordance with a preferred embodiment of the present invention; and

FIG. 16 is a flowchart representation of a process of recovery from a fault or compromise in accordance with a preferred embodiment of the present invention.

### DETAILED DESCRIPTION OF THE PREFERRED EMBODIMENT

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

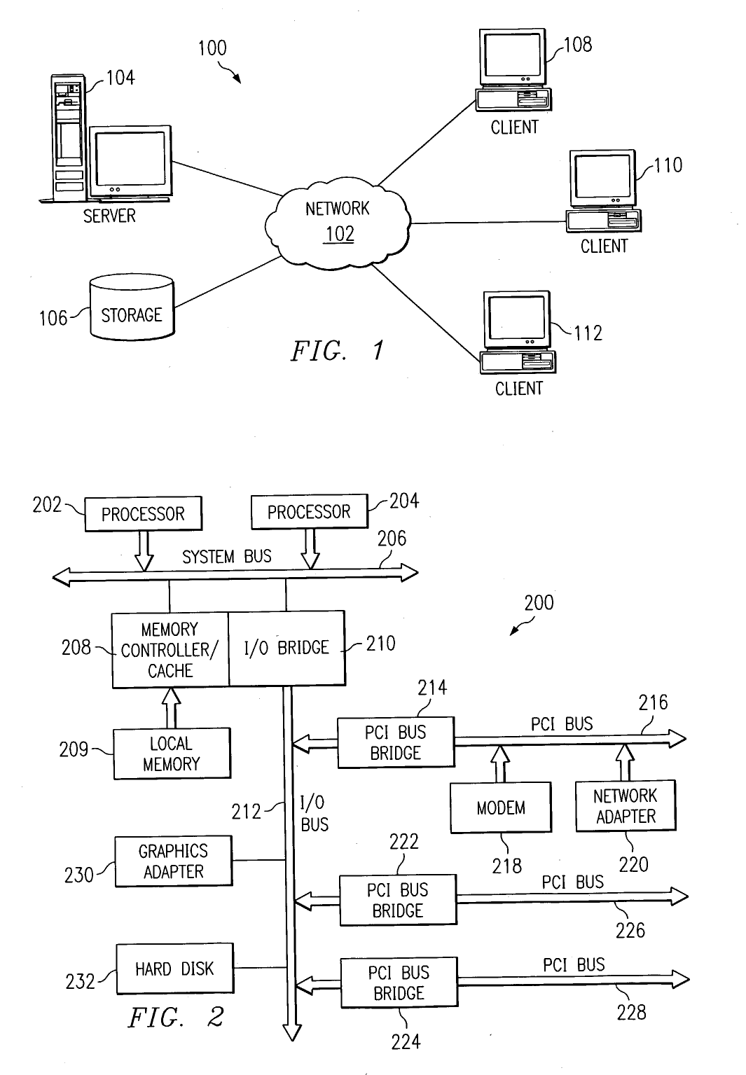

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, N.Y., running the Advanced Interactive Executive (AIX) operating system or LINUX operating system.

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interfaces As a further example, data processing system 300 may be a personal digital assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

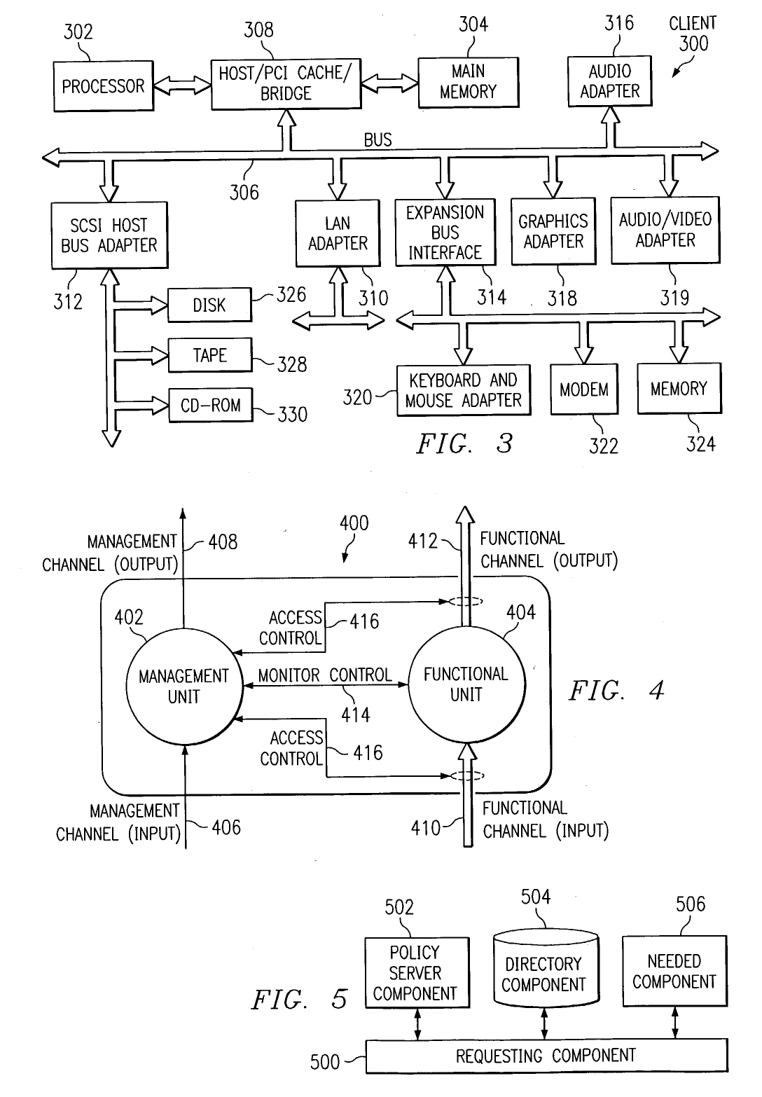

The present invention is directed to a method and apparatus for constructing a self-managing distributed computing system. The hardware and software components making up such a computing system (e.g., databases, storage systems, Web servers, file servers, and the like) are self-managing components called “autonomic elements.” Autonomic elements couple conventional computing functionality (e.g., a database) with additional self-management capabilities. FIG. 4 is a diagram of an autonomic element in accordance with a preferred embodiment of the present invention. According to the preferred embodiment depicted in FIG. 4, an autonomic element 400 comprises a management unit 402 and a functional unit 404. One of ordinary skill in the art will recognize that an autonomic element need not be clearly divided into separate units as in FIG. 4, as the division between management and functional units is merely conceptual.

Management unit 402 handles the self-management features of autonomic element 400. In particular, management unit 402 is responsible for adjusting and maintaining functional unit 404 pursuant to a set of goals for autonomic element 400, as indicated by monitor/control interface 414. Management unit 402 is also responsible for limiting access to functional unit 404 to those other system components (e.g., other autonomic elements) that have permission to use functional unit 404, as indicated by access control interfaces 416. Management unit 402 is also responsible for establishing and maintaining relationships with other autonomic elements (e.g., via input channel 406 and output channel 408).

Functional unit 404 consumes services provided by other system components (e.g., via input channel 410) and provides services to other system components (e.g., via output channel 412), depending on the intended functionality of autonomic element 400. For example, an autonomic database element provides database services and an autonomic storage element provides storage services. It should be noted that an autonomic element, such as autonomic element 400, may be a software component, a hardware component, or some combination of the two. One goal of autonomic computing is to provide computing services at a functional level of abstraction, without making rigid distinctions between the underlying implementations of a given functionality.

Autonomic elements operate by providing services to other components (which may themselves be autonomic elements) and/or obtaining services from other components. In order for autonomic elements to cooperate in such a fashion, one requires a mechanism by which an autonomic element may locate and enter into relationships with additional components providing needed functionality. FIG. 5 is a diagram depicting such a mechanism constructed in accordance with a preferred embodiment of the present invention.

A “requesting component” 500, an autonomic element, requires services of another component in order to accomplish its function. In a preferred embodiment, such function may be defined in terms of a policy of rules and goals. Policy server component 502 is an autonomic element that establishes policies for other autonomic elements in the computing system. In FIG. 5, policy server component 502 establishes a policy of rules and goals for requesting component 500 to follow and communicates this policy to requesting component 500. In the context of network communications, for example, a required standard of cryptographic protection may be a rule contained in a policy, while a desired quality of service (QoS) may be a goal of a policy.

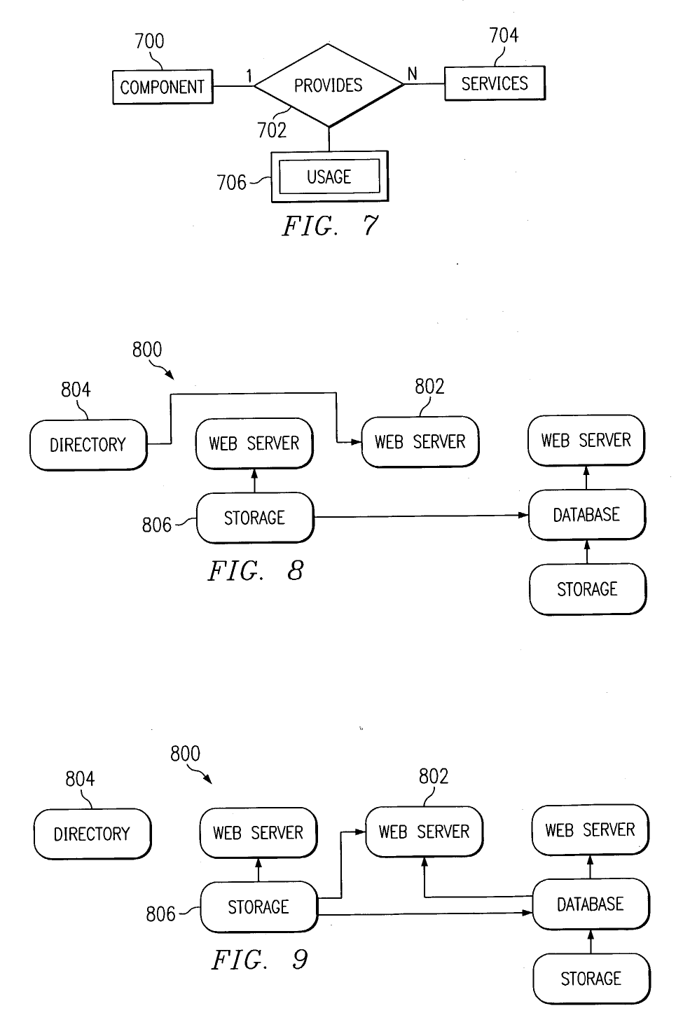

In furtherance of requesting component 500's specified policy, requesting component 500 requires a service from an additional component (for example, encryption of data). In order to acquire such a service, requesting component 500 consults directory component 504, another autonomic element. Directory component 504 is preferably a type of database that maps functional requirements into components providing the required functionality. An example of a database schema for a directory service is provided in FIG. 7.

In a preferred embodiment, directory component 504 may provide directory services through the use of standardized directory service schemes such as Web Services Description Language (WSDL) and systems such as Universal Description, Discovery, and Integration (UDDI), which allow a program to locate entities that offer particular services and to automatically determine how to communicate and conduct transactions with those services. WSDL is a proposed standard being considered by the WorldWide Web Consortium, authored by representatives of companies, such as International Business Machines Corporation, Ariba, Inc., and Microsoft Corporation. UDDI version 3 is the current specification being used for Web service applications and services. Future development and changes to UDDI will be handled by the Organization for the Advancement of Structured Information Standards (OASIS).

Directory component 504 provides requesting component 500 information to allow requesting component 500 to make use of the services of a needed component 506. Such information may include an address (such as a network address) to allow needed component 506 to be communicated with, downloadable code or the address to downloadable code to allow requesting component 500 to bind to and make use of needed component 506, or any other suitable information to allow requesting component 500 to make use of the services of needed component 506.

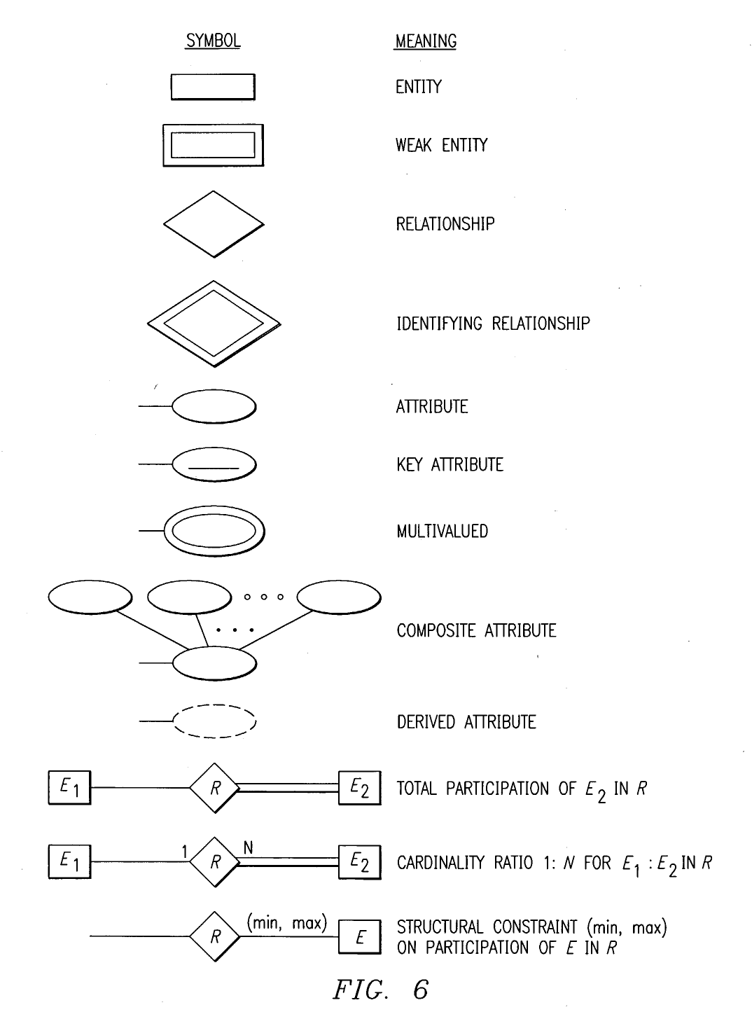

An example database schema for a directory service such as directory component 504 is provided in FIG. 7 in the form of an entity-relationship (E-R) diagram. The E-R (entity-relationship) approach to database modeling provides a semantics for the conceptual design of databases. With the E-R approach, database information is represented in terms of entities, attributes of entities, and relationships between entities, where the following definitions apply. The modeling semantics corresponding to each definition is illustrated in FIG. 6. FIG. 6 is adapted from Elmasri and Navathe, Fundamentals of Database Systems, 3rd Ed., Addison Wesley (2000), pp. 41-66, which contains additional material regarding E-R diagrams and is hereby incorporated by reference.

Entity: An entity is a principal object about which information is collected. For example, in a database containing information about personnel of a company, an entity might be “Employee.” In E-R modeling, an entity is represented with a box. An entity may be termed weak or strong, relating its dependence on another entity. A strong entity exhibits no dependence on another entity, i.e. its existence does not require the existence of another Entity. As shown in FIG. 6, a strong entity is represented with a single unshaded box. A weak entity derives its existence from another entity. For example, an entity “Work Time Schedule” derives its existence from an entity “Employee” if a work time schedule can only exist if it is associated with an employee. As shown in FIG. 6, a weak entity is represented by concentric boxes.

Attribute: An attribute is a label that gives a descriptive property to an entity (e.g., name, color, etc.). Two types of attributes exist. Key attributes distinguish among occurrences of an entity. For example, in the United States, a Social Security number is a key attribute that distinguishes between individuals. Descriptor attributes merely describe an entity occurrence (e.g., gender, weight). As shown in FIG. 6, in E-R modeling, an attribute is represented with an oval tied to the entity (box) to which it pertains.

In some cases, an attribute may have multiple values. For example, an entity representing a business may have a multivalued attribute “locations.” If the business has multiple locations, the attribute “locations” will have multiple values. A multivalued attribute is represented by concentric ovals, as shown in FIG. 6. In other cases, an composite attribute may be formed from multiple grouped attributes. A composite attribute is represented by a tree structure, as shown in FIG. 6. A derived attribute is an attribute that need not be explicitly stored in a database, but may be calculated or otherwise derived from the other attributes of an entity. A derived attribute is represented by a dashed oval as shown in FIG. 6.

Relationships: A relationship is a connectivity exhibited between entity occurrences. Relationships may be one to one, one to many, and many to many, and participation in a relationship by an entity may be optional or mandatory. For example, in the database containing information about personnel of a company, a relation “married to” among employee entity occurrences is one to one (if it is stated that an employee has at most one spouse). Further, participation in the relation is optional as there may exist unmarried employees. As a second example, if company policy dictates that every employee have exactly one manager, then the relationship “managed by” among employee entity occurrences is many to one (many employees may have the same manager), and mandatory (every employee must have a manager).

As shown in FIG. 6, in E-R modeling a relationship is represented with a diamond. Relationships may involve two or more entities. The cardinality ratio (one-to-one, one-to-many, etc.) in a relationship is denoted by the use of the characters “1” and “N” to show 1:1 or 1:N cardinality ratios, or through the use of explicit structural constraints, as shown in FIG. 6. When all instances of an entity participate in the relationship, the entity box is connected to the relationship diamond by a double line; otherwise, a single line connects the entity with the relationship, as in FIG. 6. In some cases, a relationship may actually identify or define one of the entities in the relationship. These identifying relationships are represented by concentric diamonds, also shown in FIG. 6.

Turning now to FIG. 7, an example database schema for a directory service in accordance with a preferred embodiment of the present invention is provided. It should be noted that the example schema provided in FIG. 7 is merely illustrative in nature and is not intended to limit the scope of the present invention to any particular database structure. FIG. 7 is merely intended to illustrate possible contents and organization of a directory service database in accordance with a preferred embodiment of the present invention.

A component entity 700 represents individual autonomic elements in the computing system. Each component (700) provides (provides relationship 702) a number of services (services entity 704). In order for a component to provide desired services, however, the component must be “used” in a particular way, represented by usage entity 706, which forms the third participant in the ternary relationship provides 702. Usage entity 706 represents instructions for utilizing the services of the component in question. These instructions may include the executable code of the component in the case of a software-based autonomic element, an address at which the component may be communicated with, or any other information that would allow an autonomic element to enter into a relationship with the component in question.

A database schema such as the schema described in FIG. 7 may be implemented using a database management system, such as a relational, object-oriented, object-relational, or deductive database management system. Other data storage paradigms are also possible within a preferred embodiment of the present invention as are available in the art.

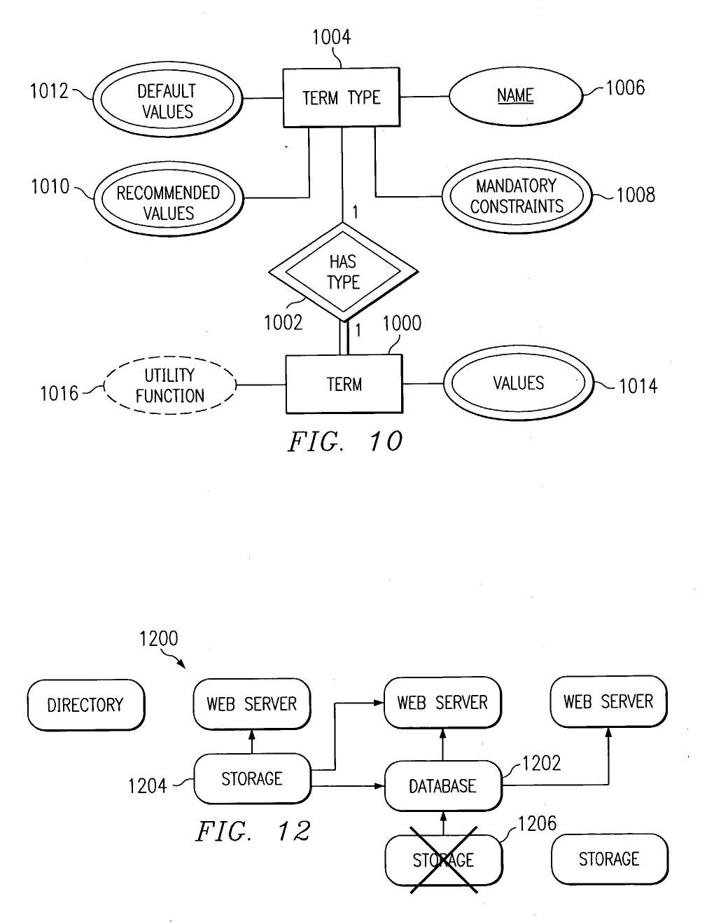

FIGS. 8-9 provide an example of an autonomic element utilizing the services of another autonomic element in accordance with a preferred embodiment of the present invention. Turning to FIG. 8, a computing system 800 comprising various autonomic elements is depicted. One such autonomic element, a web server element 802, requires storage space for holding web pages. In order to utilize storage services, web server element 802 consults directory component 804, which catalogs all of the available autonomic elements' services in computing system 800.

In FIG. 8, storage element 806 has storage space available for web server element 802's use. Directory component 804 will reflect this availability of space and return instructions to web server element 802 for using storage component 806 for web server element 802's storage needs. In FIG. 9, web server element 802 is shown as having entered into a relationship with storage element 806 in accordance with the instructions provided by directory component 804.

In entering into a relationship with storage element 806, web server element 802 will, in a preferred embodiment, negotiate the terms of the relationship in accordance with the policies of storage element 806 and web server element 802. One skilled in the art will recognize that such terms will vary, depending on the particular services being utilized. Generally speaking, however, the terms of a relationship will be derived in a back-and-forth exchange between two autonomic elements. This exchange may, in a preferred embodiment, take place using a data interchange language such as XML (eXtensible Markup Language), XML Schema, or some other language for exchanging machine-readable structured information.

In general, the terms of a relationship between two autonomic elements may be expressed as attribute-value pairs, and a policy may provide rules and goals that set bounds on acceptable and recommended values, as well as default values that may be applied in the absence of strong requirements by either side. FIG. 10 is an E-R diagram depicting how the terms of a relationship between two autonomic elements may be governed by a policy in accordance with a preferred embodiment of the present invention.

With respect to one of the autonomic elements in a relationship, a term of the relationship (for example, quality of service in a network connection) is represented by term entity 1000. Each term (1000) has a type, represented by term type entity 1004 and “has type” relationship 1002. For example, in the case of a term representing quality of service, the term type is “quality of service.” Term types are identified by their “name” in this example (name attribute 1006). Each negotiated term (1000) may have multiple values (values attribute 1014) that are consistent with the agreed-upon terms of the relationship. For example, two autonomic elements may, through negotiation, agree that two different speeds of data transfer will be allowed; in such a case, the “data transfer speed” term will have two different values, representing different speeds.

In a particular autonomic element's policy, each term type (1014) may have mandatory constraints (mandatory constraints attribute 1008), recommended values (recommended values attribute 1010), default values (default values attribute 1012), or some combination of these three attributes. Optionally, each setting of values may have associated with it a scalar utility that represents the relative desirability of that setting of values; the mapping from each possible setting of values to the utility is known as the utility function (utility function 1016). Mandatory constraints (1008) represent inviolable constraints on the value(s) which a term of the particular type in question may hold in accordance with the policy of the autonomic element in question. Recommended values (1010) represent preferred values or ranges of values that the term of the particular type should hold in accordance with the policy of the autonomic element in question, but these recommended values are not requirements (i.e., they are negotiable). Default values (1012) represent “off-the-shelf” values for particular terms that may be filled in when the other party (autonomic element) to a relationship expresses no preference with respect to that term; default values allow less important details of a relationship to be definitively determined in the negotiation process. The utility function may be a fixed relationship that is established when the autonomic element is first composed or deployed, or it may be input by a human at any time during or after the deployment of the autonomic element, or it may be computed dynamically from models that the autonomic element may employ to assess the impact of obtaining or providing a service with a proposed setting of values.

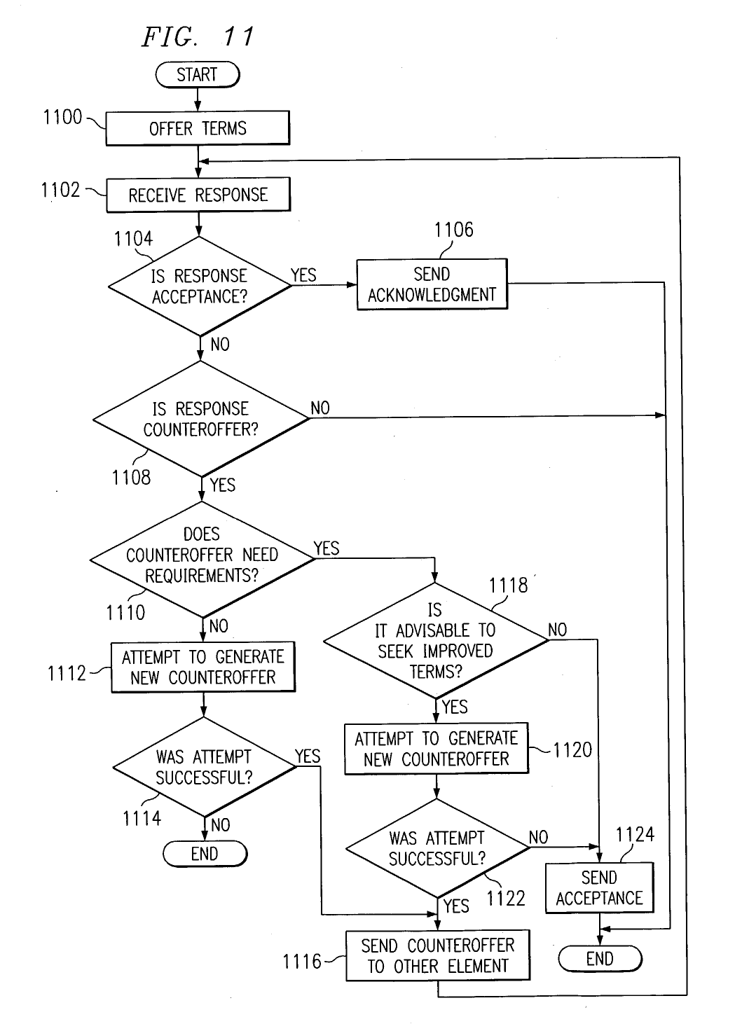

FIG. 11 is a flowchart representation of a process of negotiating terms of a relationship between two autonomic elements as seen from the perspective of one of the elements in accordance with a preferred embodiment of the present invention. An offer of terms to govern a relationship between the two elements is presented to the other element (block 1100). A response is received from the other autonomic element (block 1102). If the response is an acceptance of the original offer (block 1104:Yes), then an acknowledgement is sent to the other autonomic element to indicate that the relationship will begin according to the agreed-upon terms (block 1106).

If the response was not an acceptance (block 1104:No), a determination is then made as to whether the response was, in fact, a counteroffer providing terms that differ from the last set of terms offered (block 1108). If the response is not a counteroffer (block 1108:No), then negotiations have failed, and the process terminates. If the response is a counteroffer (block 1108:Yes), then a determination is made as to whether the terms of the counteroffer meet the requirements of the policy (i.e., they comply with any mandatory constraints) (block 1110). If the terms do not meet policy requirements (block 1110:No), an attempt is made to generate a new counteroffer that does comply with policy requirements (block 1112). If the attempt is successful (block 1114:Yes), the counteroffer is presented to the other autonomic component and the process cycles to block 1102 to receive the next response. If the attempt does not succeed (block 1114:No), the process terminates in failure.

If the counteroffer received in block 1102 does meet the requirements, however, (block 1110:Yes), the policy is consulted to determine whether it would be advisable to seek improved terms (i.e., terms that better meet recommended values) (block 1118). If so (block 1118:Yes), an attempt is made to generate a new counteroffer with more desirable terms (block 1120). For example, if a utility function is being used, an attempt would be made to generate a new counteroffer that has a higher utility. If this attempt is successful, the counteroffer is sent to the other autonomic element (block 1116) and the process cycles to block 1102 to receive the next response. If the attempt to form a new counteroffer was not successful (block 1122:No) or it was determined that seeking improved terms was not advisable (block 1118), an acceptance of the other element's terms is sent to the other autonomic element (block 1124).

In a second preferred embodiment, the negotiation may take a more asymmetric form. In the asymmetric negotiation, only one party generates proposed offers, and the other either accepts or rejects them. More specifically, a first party may at each stage of the negotiation propose one or more offers, or terminate the negotiation. The second party may refuse all of the proposed offers, accept at most one of them, or signal that it wishes to terminate the negotiation. The negotiation proceeds until one party or the other explicitly terminates it. Even if the second party accepts an offer, the first party may at the next stage propose a new set of offers that are more beneficial to it, in hopes that one of them will also prove more desirable to the second party. When the negotiation terminates, the most recently accepted offer will be taken as the agreement; if there is no accepted offer then the two parties have failed to reach an agreement.

An important aspect of self-management is the ability to detect and handle faults that may occur in a computing system. Various fault-tolerance schemes may be incorporated into the present invention to allow for self-management of faults. A fault in a computing system may be the result of a malfunction in one or more components. For example, a disk drive may physically break, rendering a storage element inoperable. Another source of faults is an active attack. In an active attack, one or more components are targeted and sabotaged. This may be the result of computer viruses, network attacks (such as denial of service attacks), security breaches, and the like. A truly autonomic computing system should be capable of automatically detecting and handling faults in real time.

FIGS. 12-15 provide an example of fault detection and handling in an autonomic computing system in accordance with a preferred embodiment of the present invention. It is important to realize that the fault-tolerance techniques depicted in FIGS. 12-15 are merely an example of fault detection and handling in a preferred embodiment of the present invention and are not intended to be limiting.

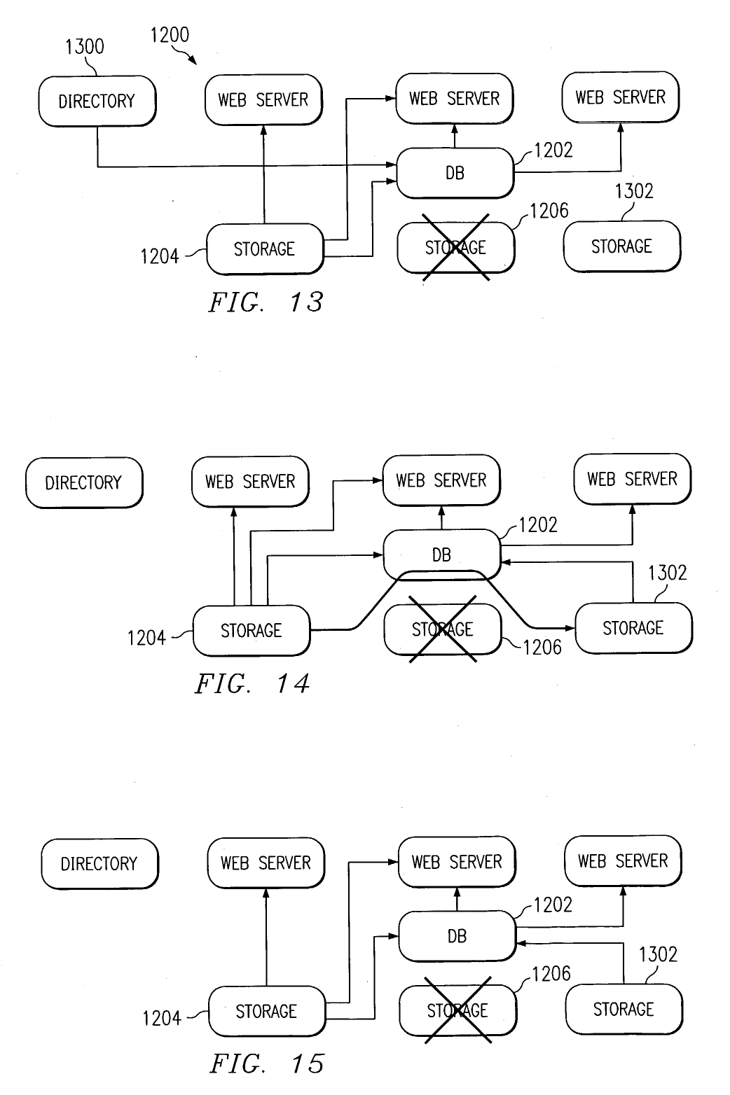

FIG. 12 is a diagram of a computing system 1200 comprising a number of autonomic elements. Database element 1202 provides database services and utilizes the storage services of storage element 1206 and redundant storage element 1204. As indicated in the diagram, storage element 1206 has become inoperable. Database element 1202, which maintains communication with storage element 1206, will detect the malfunction of storage element 1206 and terminate its relationship with storage element 1206, as shown in FIG. 13.

In FIG. 13, in response to terminating the relationship with storage element 1206, database element 1202 consults directory element 1300 to locate additional storage services in computing system 1200. Directory element 1300 indicates to database element 1202 that storage element 1302 is available for use. In response to directory element 1300's identifying storage element 1302 as an available storage element, database element 1202 enters into a relationship with storage element 1302, as shown in FIG. 14.

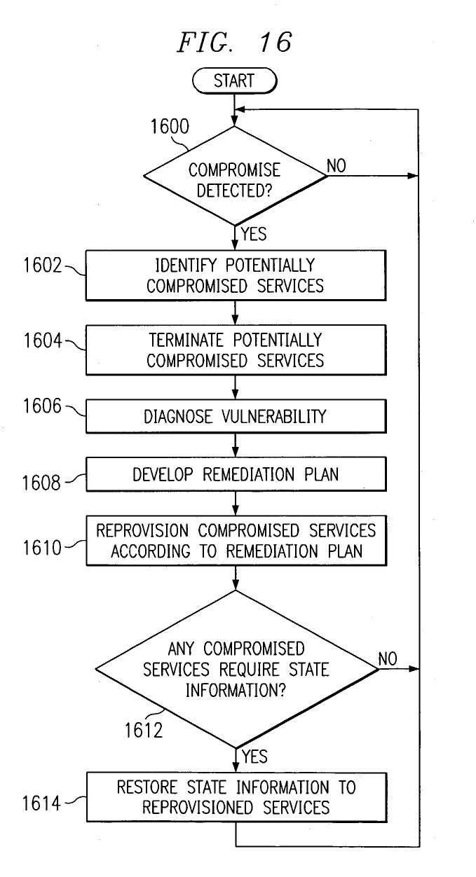

In order to reestablish redundant services in preparation for any future fault that may occur, database element 1202 copies state information from storage element 1204 to storage element 1302, as shown in FIG. 14. Once the state information from database element 1202 is copied to storage element 1302, storage element 1302 now functions in place of the inoperable storage element 1206, as shown in FIG. 15.

FIG. 16 is a flowchart representation of a process of recovery from a fault or compromise in accordance with a preferred embodiment of the present invention. If a compromise of one or more components in the computing system is detected, either via attack or malfunction (block 1600), the services that are potentially compromised thereby are identified (block 1602). Those services are then terminated (block 1604). If any particular vulnerabilities making the affected services susceptible to compromise can be identified, such vulnerabilities are diagnosed (block 1606). A plan of action for remediating the compromised state of the computing system is formulated (block 1608); examples of such remediation plans include increasing security measures, increasing the level of redundancy or error correction, and the like. The plan is then executed to reprovision the compromised elements and restore service (block 1610). If any of the compromised services are stateful (i.e., they require state information) (block 1612:Yes), the state information is restored to the reprovisioned services (block 1614). In any case, the process will finally cycle to block 1600 in preparation for any future faults.

It is important to note that while the present invention has been described in the context of a fully functioning data processing system, those of ordinary skill in the art will appreciate that the processes of the present invention are capable of being distributed in the form of a computer readable medium of instructions or other functional descriptive material and in a variety of other forms and that the present invention is equally applicable regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system. Functional descriptive material is information that imparts functionality to a machine. Functional descriptive material includes, but is not limited to, computer programs, instructions, rules, facts, definitions of computable functions, objects, and data structures.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

For purposes of this application a set is defined as zero or more things. A plurality is defined as one or more things. A subset of a set or plurality is defined as a set comprising zero or more things, all of which are taken from the original set or plurality.

What is claimed is:

1. A computer based method for managing at least one component in a computing environment, the method comprising:
identifying a particular functionality required by a first component in a data processing system;
locating information in a directory regarding at least one additional component, wherein the at least one additional component is adapted to provide the particular functionality;
negotiating terms by which the first component and the at least one additional component will operate; and
binding with the at least one additional component to form a relationship with the at least one additional component so as to provide the particular functionality to the first component.

2. The method of claim 1, wherein the at least one additional component includes at least one of a hardware component and a software component.

3. The method of claim 1, wherein the information includes at least one of an address of the at least one additional component, usage instructions for the at least one additional component, and program code for the at least one additional component.

4. The method of claim 1, wherein the directory forms a component in the data processing system.

5. The method of claim 1, wherein binding with the at least one additional component includes initiating communication between the first component and the at least one additional component.

6. The method of claim 1, wherein binding with the at least one additional component includes deploying the at least one additional component.

7. The method of claim 1, wherein negotiating terms includes:
receiving a set of proposed terms;
reviewing the set of proposed terms to determine if the set of proposed terms comply with a pre-determined policy; and
in response to the set of proposed terms violating the pre-determined policy, sending a second set of proposed terms that complies with the pre-determined policy.

8. The method of claim 1, wherein negotiating terms includes:
receiving a set of proposed terms;
reviewing the set of proposed terms to determine if the set of proposed terms reflect recommendations in a pre-determined policy; and
in response to the set of proposed terms not reflecting the recommendations in the pre-determined policy, sending a second set of proposed terms that better reflect the recommendations in the pre-determined policy.

9. The method of claim 1, wherein negotiating terms includes:
receiving a set of proposed terms;
reviewing the set of proposed terms in view of a pre-determined policy; and
in response to the set of proposed terms not reflecting recommendations and requirements in the pre-determined policy, sending a message indicating rejection of the set of proposed terms.

10. The method of claim 1, wherein negotiating terms includes:
receiving a plurality of sets of proposed terms;
reviewing the plurality of sets of proposed terms in view of a pre-determined policy; and
sending a message indicating acceptance of a subset of the plurality of sets of proposed terms, wherein the subset of the plurality of sets of proposed terms is selected on the basis of the pre-determined policy.

11. The method of claim 1, further comprising:
detecting a fault in the at least one additional component;
in response to detecting the fault, terminating the relationship with the at least one additional component; and
in response to terminating the relationship with the at least one additional component, binding with at least one replacement component.

12. The method of claim 11, wherein the fault is a malfunction.

13. The method of claim 11, wherein the fault is an attack on the at least one additional component.

14. The method of claim 11, further comprising:
binding with at least one redundant component, wherein the at least one redundant component maintains state information matching state information associated with the at least one additional component;
in response to terminating the relationship with the at least one additional component, restoring the state information from the at least one redundant component to the at least one replacement component.

15. A computer program product in a computer-readable medium comprising functional descriptive material that, when executed by a computer, enables the computer to perform acts including:
identifying a particular functionality required by a first component in a data processing system;
locating information in a directory regarding at least one additional component, wherein the at least one additional component is adapted to provide the particular functionality;
negotiating terms by which the first component and the at least one additional component will operate; and
binding with the at least one additional component to form a relationship with the at least one additional component so as to provide the particular functionality to the first component.

16. The computer program product of claim 15, wherein the at least one additional component includes at least one of a hardware component and a software component.

17. The computer program product of claim 15, wherein the information includes at least one of an address of the at least one additional component, usage instructions for the at least one additional component, and program code for the at least one additional component.

18. The computer program product of claim 15, wherein the directory forms a component in the data processing system.

19. The computer program product of claim 15, wherein binding with the at least one additional component includes initiating communication between the first component and the at least one additional component.

20. The computer program product of claim 15, wherein binding with the at least one additional component includes deploying the at least one additional component.

21. The computer program product of claim 15, wherein negotiating terms includes:
receiving a set of proposed terms;
reviewing the set of proposed terms to determine if the set of proposed terms comply with a pre-determined policy; and
in response to the set of proposed terms violating the pre-determined policy, sending a second set of proposed terms that complies with the pre-determined policy.

22. The computer program product of claim 15, wherein negotiating terms includes:
receiving a set of proposed terms;
reviewing the set of proposed terms to determine if the set of proposed terms reflect recommendations in a pre-determined policy; and
in response to the set of proposed terms not reflecting the recommendations in the pre-determined policy, sending a second set of proposed terms that better reflect the recommendations in the pre-determined policy.

23. The computer program product of claim 15, wherein negotiating terms includes:
receiving a set of proposed terms;
reviewing the set of proposed terms in view of a pre-determined policy; and
in response to the set of proposed terms not reflecting recommendations and requirements in the pre-determined policy, sending a message indicating rejection of the set of proposed terms.

24. The computer program product of claim 15, wherein negotiating terms includes:
receiving a plurality of sets of proposed terms;
reviewing the plurality of sets of proposed terms in view of a pre-determined policy; and
sending a message indicating acceptance of a subset of the plurality of sets of proposed terms, wherein the subset of the plurality of sets of proposed terms is selected on the basis of the pre-determined policy.

25. The computer program product of claim 15, comprising additional functional descriptive material that, when executed by the computer, enables the computer to perform additional acts including:
detecting a fault in the at least one additional component;
in response to detecting the fault, terminating the relationship with the at least one additional component; and
in response to terminating the relationship at least one additional component, binding with at least one replacement component.

26. The computer program product of claim 25, wherein the fault is a malfunction.

27. The computer program product of claim 25, wherein the fault is an attack on the at least one additional component.

28. The computer program product of claim 25, comprising additional functional descriptive material that, when executed by the computer, enables the computer to perform additional acts including:
binding with at least one redundant component, wherein the at least one redundant component maintains state information matching state information associated with the at least one additional component;
in response to terminating the relationship with at least one additional component, restoring the state information from the at least one redundant component to the at least one replacement component.

29. A data processing system comprising:
means for identifying a particular functionality required by a first component in a data processing system;
means for locating information in a directory regarding at least one additional component, wherein the at least one additional component is adapted to provide the particular functionality;
means for negotiating terms by which the first component and the at least one additional component will operate; and
means for binding with the at least one additional component to form a relationship with the at least one additional component so as to provide the particular functionality to the first component.

30. The data processing system of claim 29, wherein the at least one additional component includes at least one of a hardware component and a software component.

31. The data processing system of claim 29, wherein the information includes at least one of an address of the at least one additional component, usage instructions for the at least one additional component, and program code for the at least one additional component.

32. The data processing system of claim 29, wherein the directory forms a component in the data processing system.

33. The data processing system of claim 29, wherein binding with the at least one additional component includes initiating communication between the first component and the at least one additional component.

34. The data processing system of claim 29, wherein binding with the at least one additional component includes deploying the at least one additional component.

35. The data processing system of claim 29, wherein negotiating terms includes:
receiving a set of proposed terms;
reviewing the set of proposed terms to determine if the set of proposed terms comply with a pre-determined policy; and
in response to the set of proposed terms violating the pre-determined policy, sending a second set of proposed terms that complies with the pre-determined policy.

36. The data processing system of claim 29, wherein negotiating terms includes:
receiving a set of proposed terms;
reviewing the set of proposed terms to determine if the set of proposed terms reflect recommendations in a pre-determined policy; and
in response to the set of proposed terms not reflecting the recommendations in the pre-determined policy, sending a second set of proposed terms that better reflect the recommendations in the pre-determined policy.

37. The data processing system of claim 29, wherein negotiating terms includes:
receiving a set of proposed terms;
reviewing the set of proposed terms in view of a pre-determined policy; and
in response to the set of proposed terms not reflecting recommendations and requirements in the pre-determined policy, sending a message indicating rejection of the set of proposed terms.

38. The data processing system of claim 29, wherein negotiating terms includes:
receiving a plurality of sets of proposed terms;
reviewing the plurality of sets of proposed terms in view of a pre-determined policy; and
sending a message indicating acceptance of a subset of the plurality of sets of proposed terms, wherein the subset of the plurality of sets of proposed terms is selected on the basis of the pre-determined policy.

39. The data processing system of claim 29, further comprising:
means for detecting a fault in the at least one additional component;
means, responsive to detecting the fault, for terminating the relationship with the at least one additional component; and
means, responsive to terminating the relationship with the at least one additional component, for binding with at least one replacement component.

40. The data processing system of claim 39, wherein the fault is a malfunction.

41. The data processing system of claim 39, wherein the fault is an attack on the at least one additional component.

42. The data processing system of claim 39, further comprising:
means for binding with at least one redundant component, wherein the at least one redundant component maintains state information matching state information associated with the at least one additional component;
means, responsive to terminating the relationship with the at least one additional component, for restoring the state information from the at least one redundant component to the at least one replacement component.
